(19) United States
(12) Patent Application Publication
(10) Pub. No.: US 2006/0210868 A1
(43) Pub. Date: Sep. 21, 2006

(54) Secondary battery module

(76) Inventors: Tae-Yong Kim, Yongin (KR); Gun-Goo Lee, Yongin (KR); Yoon-Cheol Jeon, Yongin (KR)

Correspondence Address: ROBERT E. BUSHNELL, 1522 K STREET NW, SUITE 300, WASHINGTON, DC, 20005-1202, US

(21) Appl. No.: 11/375,025

(22) Filed: Mar. 15, 2006

(30) Foreign Application Priority Data
Mar. 21, 2005 (KR) 10-2005-0023209

(51) Int. Cl. H01M 10/50; H01M 2/12

(52) U.S. Cl. 429/120; 429/83

(57) ABSTRACT

A secondary battery module includes a unit battery, a housing receiving the unit battery, the housing having an inlet and an outlet to allow a heat transfer medium to flow in and out of the housing passed the unit battery, and a positive temperature coefficient (PTC) heater disposed in the housing to heat the heat transfer member flowed through the housing.

### CLAIM OF PRIORITY

This application makes reference to, incorporates the same herein, and claims all benefits accruing under 35 U.S.C. §119 from an application for SECONDARY BATTERY MODULE, earlier filed in the Korean Intellectual Property Office on 21 Mar. 2005 and there duly assigned Serial No. 10-2005-0023209.

### BACKGROUND OF THE INVENTION

1. Field of the Invention

The present invention relates to a secondary battery, and more particularly, to a system for controlling temperature of a secondary battery module in which, when the battery module is formed by connecting unit batteries, the temperature of the battery module can be easily controlled.

2. Description of the Related Art

The non-aqueous electrolyte secondary batteries of high energy density have recently been developing as high power secondary batteries, and bulk size batteries are formed by serially connecting several to tens of the high power secondary batteries to be suitable for motor drive of the machines requiring high power source such as hybrid electric vehicles.

Such a bulk size secondary battery assembly (hereinafter “secondary battery module” or “battery module”) is generally comprised of plural secondary batteries (hereinafter “unit battery”) serially connected to each other.

If the unit batteries are square type batteries, the unit batteries are arranged to alternate the positive and negative terminals of one unit battery with the positive and negative terminals of the other adjacent unit battery, and adaptors of the electric conductor are mounted in the negative terminals and the positive terminals having partly threaded outer surfaces by use of nuts, and thereby they are electrically connected with each other to form the secondary battery module.

However, the secondary battery module has a problem that the power performance is lowered at lower temperature. Especially, if the bulk size secondary battery module for hybrid electric vehicles (HEV) is used under the intense cold environment such as winter time, it can not provide the desired power at sub-zero temperature.

Moreover, as the recent vehicle engine emits less heat due to the development of the vehicle technology, there is a much more difficult problem that the secondary battery module cannot provide a proper power at low temperature environment.

The above information is only for enhancement of understanding of the background of the invention and therefore it may contain information that does not form the prior art that is already known in this country to a person of ordinary skill in the art.

### SUMMARY OF THE INVENTION

The present invention has been made in an effort to provide a secondary battery module which can easily heat the unit battery even under the extremely intense environment to ensure a proper power.

A exemplary secondary battery module according to an exemplary embodiment of the present invention includes a unit battery; a housing receiving the unit battery, the housing having an inlet and an outlet to allow a heat transfer medium to flow in and out of the inlet and outlet, respectively; and a positive temperature coefficient (PTC) heater disposed in the inlet side to heat the heat transfer medium flowing into the housing.

The PTC heater may include a PTC device having a body with a plurality of through holes.

A ventilator may be disposed in the inlet to accelerate the flow in of the heat transfer medium, and the ventilator may be disposed in front of the PTC heater.

The heat transfer medium may be air.

The secondary battery module may be mounted in a vehicle, and the PTC heater is powered by a lead acid battery or a generator mounted in the vehicle.

The secondary battery module may further comprise a temperature sensor disposed in the housing to detect temperature of the unit battery.

The secondary battery module may further comprise a battery management system receiving the temperature information of the unit battery from the temperature sensor and controlling the operation of the PTC heater.

A secondary battery module according to another exemplary embodiment of the present invention includes a plurality of unit batteries; cell barriers disposed between the unit batteries; a housing receiving the unit batteries and the cell barriers, the housing having an inlet and an outlet to allow a heat transfer medium to flow in and out of the inlet and outlet, respectively; and positive temperature coefficient (PTC) heaters disposed within the cell barriers between the unit batteries.

A secondary battery module according to another exemplary embodiment of the present invention includes a plurality of unit batteries; a housing receiving the unit batteries; a thermal conductive member disposed in the outer surface of the housing; and positive temperature coefficient (PTC) heaters disposed in the thermal conductive member.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional side view of a secondary battery module according to a first exemplary embodiment of the present invention;

FIG. 2 is a perspective view of a positive temperature coefficient (PTC) heater according to the first exemplary embodiment of the present invention;

FIG. 3 is a schematic cross-sectional side view of a secondary battery module according to a second exemplary embodiment of the present invention;

FIG. 4 is a schematic cross-sectional plan view of a secondary battery module according to the second exemplary embodiment of the present invention;

FIG. 5 is a schematic partial cross-sectional plan view of a secondary battery module according to a third exemplary embodiment of the present invention;

FIG. 6 is a schematic partial cross-sectional plan view of a secondary battery module according to a fourth exemplary embodiment of the present invention; and

FIG. 7 is a schematic partial cross-sectional plan view of a secondary battery module according to a fifth exemplary embodiment of the present invention.

### DETAILED DESCRIPTION OF THE INVENTION

Exemplary embodiments of the present invention will hereinafter be described in detail with reference to the accompanying drawings.

In the following embodiment, the secondary battery module adopts an air cooling system which uses an exterior air as a coolant. However, the cooling system of the present invention is not limited to the above structure, for example, it can use a vehicle's air conditioning system.

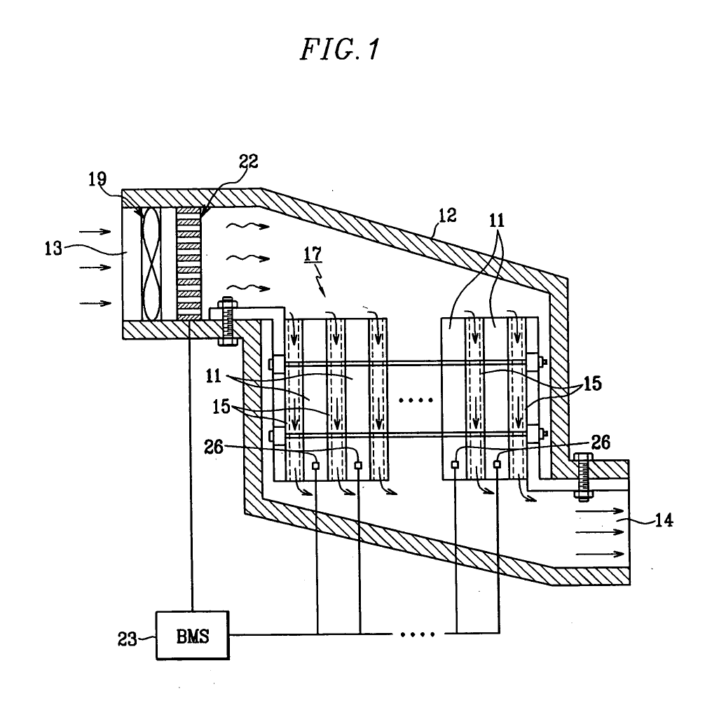

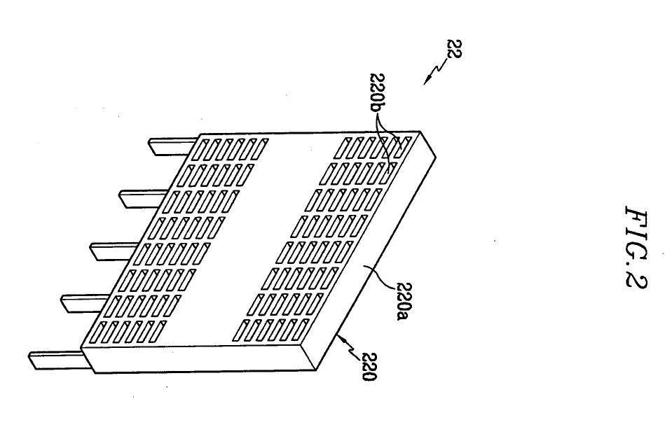

FIG. 1 is a schematic cross-sectional side view of a secondary battery module according to the first exemplary embodiment of the present invention, and FIG. 2 is a perspective view of a positive temperature coefficient (hereinafter, PTC) heater according to the first exemplary embodiment of the present invention;

Referring to the drawings, a secondary battery module includes a plurality of unit batteries 11, a battery aggregate 17 having cell barriers 15 disposed between the unit batteries 11, and a housing 12 receiving the battery aggregate 17.

Each unit battery 11 in the present exemplary embodiment is a lithium type secondary battery of a square shape, which includes (not sown) an electrode assembly having a positive electrode, a negative electrode and a separator, and a container receiving the electrode assembly.

The housing 12 has an inlet 13 formed on one side thereof to allow air, for controlling the temperature of the unit batteries 11, to flow in, and an outlet 14 formed on the other side thereof to allow the air, passed through the battery aggregate 17, to flow out. Thus, an air flow channel is formed between the inlet 13 and the outlet 14 inside the housing 12.

In the present invention, the shape of the housing 12, the location of the inlet 13 and the outlet 14 inside the housing 12, and the array structure of the unit batteries 11 inside the housing 12 are not limited as far as they meet the above structure.

In the present exemplary embodiment, the inlet 13 is formed in the upper portion of the housing 12, and the outlet 14 is formed in the lower portion of the housing 12, as shown in FIG. 1. In addition, the housing 12 has a structure that the air flow channel is gradually narrower as it goes from the inlet 13 forming side to the inlet 13 facing side, and the air flow channel is also gradually narrower as it goes from the outlet 14 forming side to the outlet 13 facing side.

The secondary battery module includes a PTC heater 22 disposed in the inlet 13 side of the housing 12 to heat air as it is flowing into the housing 12, and a ventilator 19 disposed in front of (or in back of) the PTC heater 22 to accelerate the air flow into the housing 12.

The PTC heater 22 is an exothermic device having a PTC device called as a positive temperature coefficient thermistor, and may be made of Ba₂TiO₃ type ceramic material, and it is a semiconductor device which increases resistance as temperature increases. As the PCT device changes resistance at or around Curie temperature, its temperature is appropriately controlled to thereby maintain the temperature stably.

As the PTC heater 22 with the PTC device does not produce any by-product causing a fire such as a spark, when heating, it has no fire risk, and accordingly, it has an advantage that it can maintain the temperature of the apparatus having it constant without a separate controller.

The PTC heater 22 of the present exemplary embodiment, as shown in FIG. 2, is comprised of a PTC device 220 having a ceramic body 220a of Ba₂TiO₃ type with a plurality of through holes 220b. It is preferable that the ceramic body 220a has a shape corresponding to the cross sectional shape of the inlet 13. Accordingly, the ceramic body 220a in the present exemplary embodiment has a square or rectangular shape.

The flow path of air provided into the housing 12 in the secondary battery module with the PTC heater 22 is such that the air flows into the inside of the housing 12 through the inlet 13 and passes through the through holes 220b of the PTC heater 22 to be heated by the heat the PTC heater 22 emits. To do this, the PTC heater 22 is electrically connected to a battery management system (hereinafter, BMS) 23 managing electrical control of the secondary battery module, by which the voltage required for the driving is applied.

The heated air keeps flowing into the inside of the housing 12 to thereby pass through the cell barriers 15 disposed between the unit batteries 11. Then, heat energy of the heated air is delivered to each unit battery 11, and therefore, the unit batteries 11 can maintain proper temperature.

As described above, while the PTC heater 22 maintains the temperature for the operation, that is, the Curie temperature, above a predetermined value, it can heat the air to maintain the unit batteries 11 to have a predetermined temperature.

In the meantime, when the Curie temperature of the PTC heater 22 is set to the temperature at which the unit batteries 11 shows the maximum performance, it is expected to takes a longer time to heat the unit batteries 11 to the appropriate temperature under the intense cold environment such as sub-zero temperature in winter time than under a normal environment.

In comparison, a temperature sensor 26 can be mounted in each unit battery 11, and the PTC heater 22 can be controlled based on the comparative value between a predetermined temperature of the unit batteries 11 and a detected temperature detected by the temperature sensors 26. Such function can be performed by an operation part, a comparison part and an output part of the BMS 23.

The operation part calculates a signal output by the temperature sensors 26 to check the current temperature of the unit batteries 11, and the comparison part compares the actual temperature of the unit battery 11 checked by the operation part with a predetermined standard temperature of the unit batteries 11, and the output part applies a proper electrical signal to the PTC heater 22 based on the signal output from the comparison part, to thereby control the temperature of the PTC heater 22 and the temperature of the unit battery 11 as well.

In the meantime, wherein the secondary battery module is mounted in a machine such as hybrid electric vehicles (HEV) or electric vehicles (EV), the power applied to the PTC heater 22 can be supplied by a lead acid battery or a generator mounted in the vehicles.

That is, as the power is supplied by the lead acid battery on the ignition of the vehicle, and the power is supplied by the generator during driving of the vehicle, the PTC heater 22 can be heated.

Substantially, the power supply to the PTC heater 22 can be achieved through the BMS 23.

In addition, the ventilator 19 can be disposed in front of the PTC heater 22 to accelerate flowing in of the air. The ventilator 19 disposed in front of the PTC heater 22 flows the air into the housing 12. The flowed air is heated while passing through the PTC heater 22 to transfer the heat to each of the unit batteries 11, and it is discharged through the outlet 14.

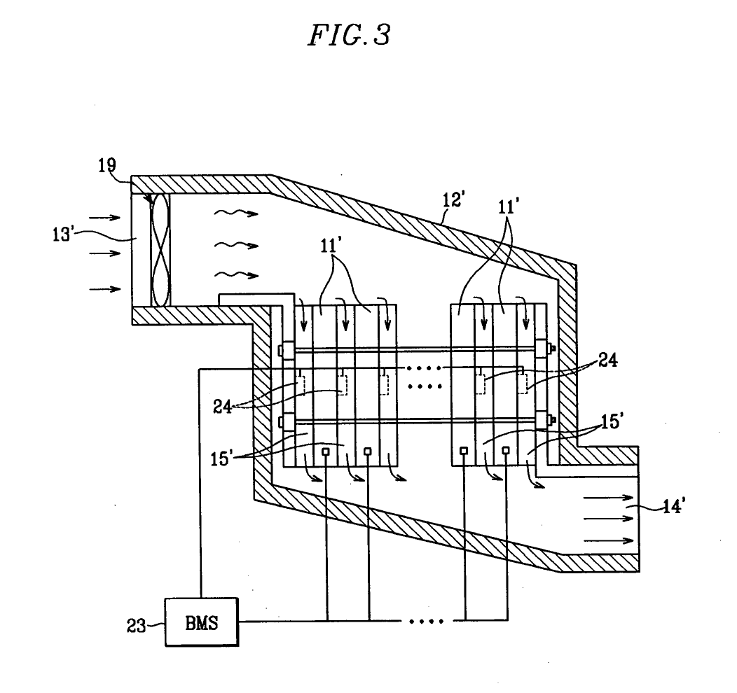

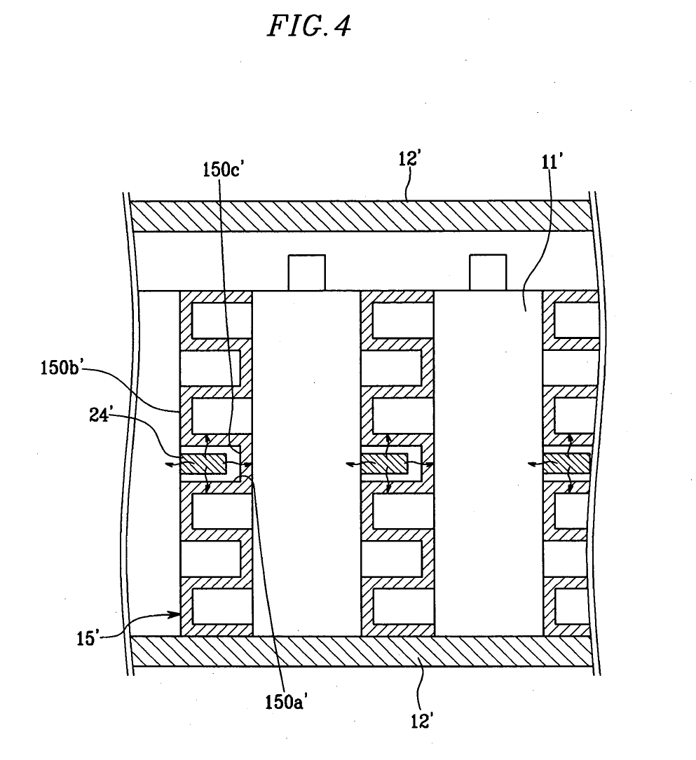

FIG. 3 is a schematic cross-sectional side view of a secondary battery module according to the second exemplary embodiment of the present invention, and FIG. 4 is a schematic cross-sectional plane view of a secondary battery module according to the second exemplary embodiment of the present invention.

The secondary battery module of the second exemplary embodiment includes a plurality of unit batteries 11′ and cell barriers 15′ between them like the secondary battery module described in the above exemplary embodiment. The air flowed in through an inlet 13′ of a housing 12′ is passed through the cell barriers 15′ to heat or cool the unit batteries 11′, and discharged through an outlet 14′.

The cell barriers 15′ of the present exemplary embodiment has across section of a meander shape, in which a plurality of concave portions 150a′ and convex portions 150b′ are perpendicularly bent and connected as shown in FIG. 4. The cell barrier 15′ has a space 150′ formed by the concave portions 150b′, and the space 150c′ can be a channel for the air to pass through.

The shape of the cell barrier 15′ is not limited to the above structure. The cell barrier 15′ of various shapes can be disposed between the unit batteries 11′.

PTC heaters 24′ in the second exemplary embodiment are disposed between the unit batteries 11′ and within respective ones of the cell barriers 15′ in the secondary battery module.

More specifically, each PTC heater 24′ is disposed in the concave portion 150b′ of each of the cell barriers 15′ to have a structure such that it is contacted with the unit battery 11′. Accordingly, the PTC heaters 24′ are not in contact with the cell barriers 15′, but instead are spaced apart therefrom as shown in FIG. 4.

In this exemplary embodiment, one PTC heater 24′ is installed in each cell barrier 15′. However, it is not limited thereto and the number of the installation can be varied when needed.

In the above secondary battery module structure, the PTC heater 24′ starts the operation to heat the cell barrier 15′ when needed under the intense cold environment.

If the cell barrier 15′ is heated as described above, the air is heated by the heat energy emitted from the cell barrier 15′ when the air passes through the cell barrier 15′, and the unit battery 11′ is heated by the air, to thereby maintain a proper operation temperature.

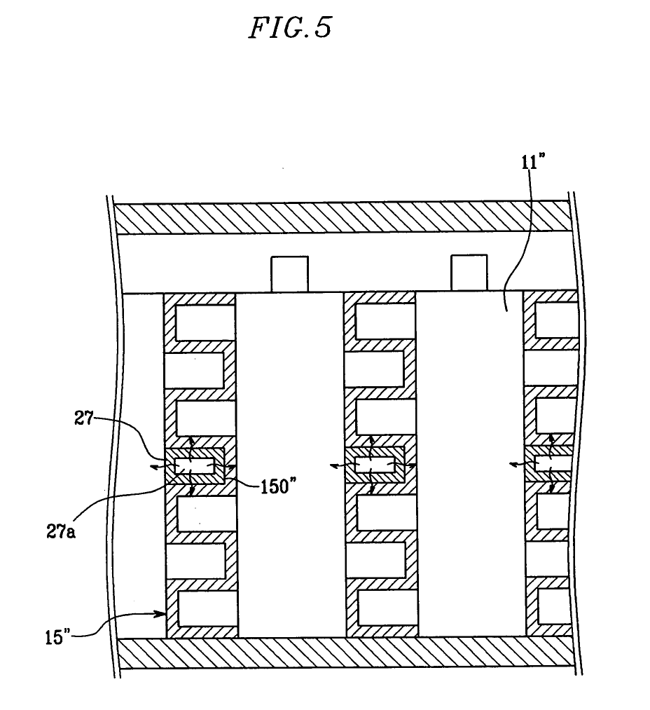

FIG. 5 is a schematic partial cross-sectional plan view of a secondary battery module according to the third exemplary embodiment of the present invention. The secondary battery module of the third exemplary embodiment has the same basic structure as the secondary battery module of the second exemplary embodiment. However, when the PTC heater 27 is disposed in the concave portion 150″ of the cell barrier 15″ while contacted with the unit battery 11″, it is closely contacted with the cell barrier 15″ without a space therebetween.

The function of the PTC heater 27 is the same as in the second exemplary embodiment, and, additionally, the PTC heater 27 may have a through hole 27a for air flow in the cell barrier 15″ to prevent the PTC heater 27 from blocking flow of the air passing through the cell barrier 15″.

The BMS and the temperature sensor mentioned in the first exemplary embodiment can be adopted in the second and the third exemplary embodiments to perform the same function.

Furthermore, the supply of the power by the lead acid battery or the generator mentioned in the first exemplary embodiment can also be adopted in the second and the third exemplary embodiments.

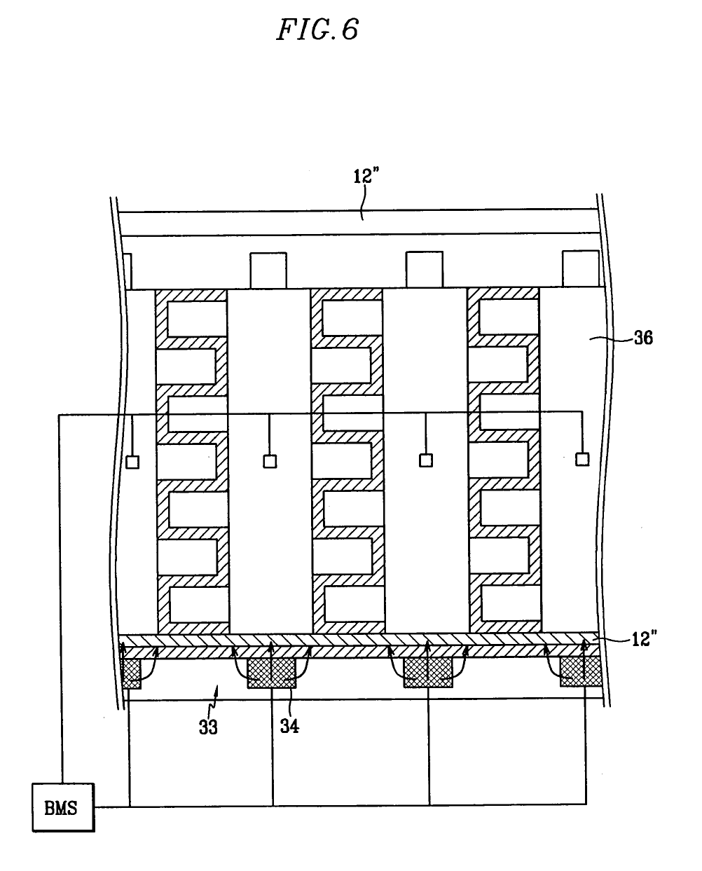

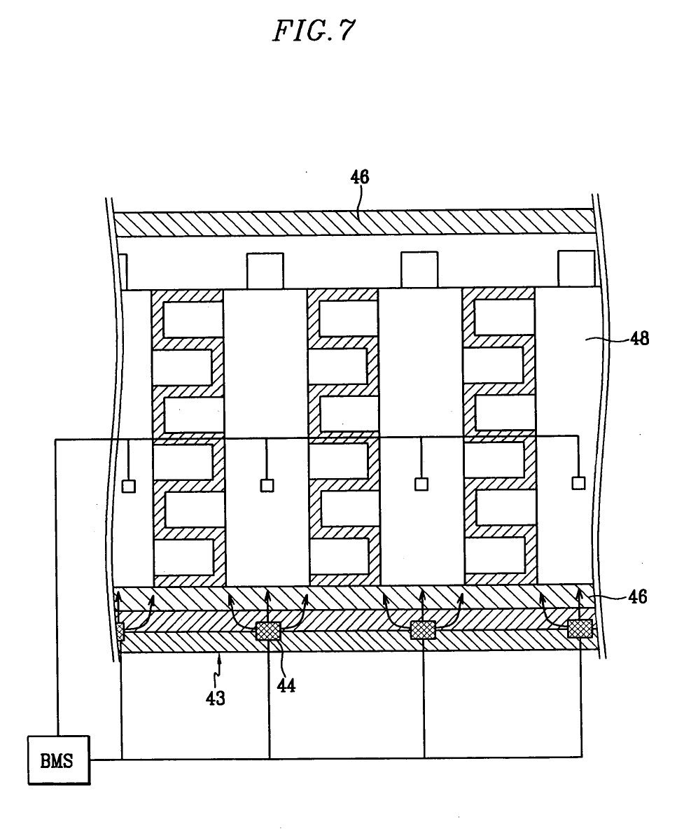

FIGS. 6 and 7 are schematic partial cross-sectional plan views of a secondary battery module according to the fourth exemplary embodiment and the fifth exemplary embodiment of the present invention. Referring to the drawings, the secondary battery module of the fourth exemplary embodiment and the fifth exemplary embodiment have the same basic structure as the secondary battery module of the second exemplary embodiment.

However, these exemplary embodiments have a difference in the mounting position of the PTC heater from the above mentioned exemplary embodiment.

The PTC heaters 34 of the secondary battery module shown in FIG. 6 are mounted in a thermal conductive member like a heat sink 33 to be connected to the housing 12″.

More specifically, the plurality of PTC heaters 34 are mounted in the heat sink 33 to be spaced apart from each other, and the heat sink 33 is disposed to be contacted with the outer surface of the housing 12″.

The reason that the heat sink 33 is disposed in the outer surface of the housing 12′ is to closely arrange the PTC heaters 34 and the unit batteries 36 of an object receiving the heat.

The secondary battery module with the above structure transfers the heat emitted from the PTC heaters 34 to the unit batteries 36 through the heat sink 33 and the housing 12″, to thereby heat the unit batteries 36.

In the secondary battery module shown in FIG. 7, in order to enhance the efficiency of the PTC heater, the PTC heaters 44 are mounted in the outer surface of a housing 46 as in the secondary battery module of the FIG. 6, and, additionally, it has a metal plate 43 as the thermal conductive member contacted with the PTC heater 44, which is closely contacted with the PTC heater 44 to cover it, the metal plate 43 being fixed to the outer surface of the housing 46.

As such, a mounting structure of the PTC heaters 44 increases contact area between the PTC heaters 44 and the thermal conductive member, the more heat emitted from the PTC heaters 44 can be transferred to the unit batteries 48 through the metal plate 43 and the housing 46.

It should be apparent that each PCT heater can be separately controlled by using the detected temperature of its closest battery.

The BMS and the temperature sensor mentioned in the first exemplary embodiment can be adopted in the fourth and the fifth exemplary embodiments to perform the same function.

Furthermore, the supply of the power by the lead acid battery or the generator mentioned in the first exemplary embodiment can also be adopted in the fourth and the fifth exemplary embodiments.

According to the present exemplary embodiment, the secondary battery module can obtain a desired output by easily heating the unit battery in low temperature environment when needed and controlling the temperature of the secondary battery module.

Moreover, as the PTC heater is a heat emitting device of low fire risk, consumers using the apparatus with the present invention can use the apparatus more safely.

The secondary battery module according to the exemplary embodiments of the present invention can be used as the power source for motor driving devices requiring high power characteristics, such as the hybrid electric vehicles, electric vehicles, wireless vacuum cleaners, motorbikes, or motor scooters.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A secondary battery module, comprising:
a unit battery;
a housing receiving the unit battery, the housing having an inlet and an outlet to allow a heat transfer medium flow to in and out of said inlet and said outlet, respectively; and
a positive temperature coefficient (PTC) heater disposed within the inlet to heat the heat transfer medium flowing into the housing.

2. The secondary battery module of claim 1, wherein the positive temperature coefficient (PTC) heater includes a positive temperature coefficient (PTC) device having a body with a plurality of through holes.

3. The secondary battery module of claim 1, wherein a ventilator is disposed in the inlet to accelerate the flow of the heat transfer medium, the ventilator being disposed in front of the positive temperature coefficient (PTC) heater.

4. The secondary battery module of claim 1, wherein the heat transfer medium is air.

5. The secondary battery module of claim 1, wherein the secondary battery module is mounted in a vehicle, and the positive temperature coefficient (PTC) heater is powered by a lead acid battery or a generator mounted in the vehicle.

6. The secondary battery module of claim 1, further comprising a temperature sensor disposed in the housing to detect temperature of the unit battery.

7. The secondary battery module of claim 6, further comprising a battery management system receiving temperature information of the unit battery from the temperature sensor and controlling the operation of the positive temperature coefficient (PTC) heater.

8. A secondary battery module, comprising:
a plurality of unit batteries;
cell barriers disposed between the unit batteries;
a housing receiving the unit batteries and the cell barriers, the housing having an inlet and an outlet to allow a heat transfer medium to flow in and out said inlet and said outlet, respectively; and
positive temperature coefficient (PTC) heaters disposed between within respective ones of the unit batteries between the cell barriers.

9. The secondary battery module of claim 8, wherein the positive temperature coefficient (PTC) heaters are in physical contact with respective ones of the unit batteries.

10. The secondary battery module of claim 9, wherein the positive temperature coefficient (PTC) heaters are in physical contact with the cell barriers.

11. The secondary battery module of claim 8, wherein each of the positive temperature coefficient (PTC) heaters has a through hole for air flowing.

12. The secondary battery module of claim 8, wherein the secondary battery module is mounted in a vehicle, and the positive temperature coefficient (PTC) heaters are powered by a lead acid battery or a generator mounted in the vehicle.

13. The secondary battery module of claim 8, further comprising a temperature sensor disposed in the housing to detect temperature of at least one of the unit batteries.

14. The secondary battery module of claim 13, further comprising a battery management system receiving temperature information from the temperature sensor and controlling the operation of the positive temperature coefficient (PTC) heaters.

15. A secondary battery module comprising:
a plurality of unit batteries;
a housing receiving the unit batteries;
a thermal conductive member disposed in the outer surface of the housing; and
positive temperature coefficient (PTC) heaters disposed in the thermal conductive member.

16. The secondary battery module of claim 15, wherein the unit batteries are disposed closely to respective ones of the positive temperature coefficient (PTC) heaters.

17. The secondary battery module of claim 15, wherein the secondary battery module is mounted in a vehicle, and the positive temperature coefficient (PTC) heaters are powered by a lead acid battery or a generator mounted in the vehicle.

18. The secondary battery module of claim 15, further comprising a temperature sensor disposed in the housing to detect temperature of at least one of the unit batteries.

19. The secondary battery module of claim 18, further comprising a battery management system receiving temperature information from the temperature sensor and controlling the operation of the positive temperature coefficient (PTC) heaters.
